(19) United States
(12) Patent Application Publication
(10) Pub. No.: US 2017/0198433 A1
(43) Pub. Date: Jul. 13, 2017

(54) Floor Protector

(71) Applicant: Jason GOLDBERG, Dalton, GA (US)

(72) Inventor: Jason GOLDBERG, Dalton, GA (US)

(21) Appl. No.: 15/404,346

(22) Filed: Jan. 12, 2017

Related U.S. Application Data
(60) Provisional application No. 62/278,114, filed on Jan. 13, 2016.

(51) Int. Cl. D06N 7/00; B32B 5/02; B32B 27/32; B32B 25/10; B32B 25/14; B32B 3/16; B32B 27/12

(52) U.S. Cl. CPC D06N 7/00; B32B 3/16; B32B 5/022; B32B 27/12; B32B 25/10; B32B 25/14; B32B 27/32; B32B 2307/7265; B32B 2471/00; D06N 2209/128

(57) ABSTRACT

A floor protector has a pair of non-woven material layers. A film layer is bonded between the pair of non-woven material layers. The film layer provides a moisture barrier. A non-skid layer is applied on one of the non-woven material layers.

### CROSS-REFERENCE TO RELATED APPLICATION

This application claims the benefit of U.S. Provisional Application No. 62/278,114, filed on Jan. 13, 2016. The entire disclosure of the above application is incorporated herein by reference.

### FIELD

The present disclosure relates to a floor protector and, more particularly, to a non-woven liquid impermeable non-skid floor covering that is utilized in new construction and remodeling to protect finished floors.

### BACKGROUND

In the building and construction fields, it is desirable to protect the finish of new floors while continued work is done in the building. Various types of floor protectors or covers exist in the field to protect finished floors from construction traffic. Various types of pulp or paper products are available as well as synthetics products. However, these types of protectors have limited life. Particularly, paper products are subjected to permeability of liquids spilt on them. The synthetic products are easily marred and rip or tear under construction traffic. Both types of products are limited in their ability to remain secured to the finished floors. The pulp and paper products require a tape while the synthetic products generally have a tactified backing. However, these floor protectors generally become displaced or damaged and must be reapplied or replaced onto the finished floors.

Generally, it is an object of the present disclosure to provide a floor protector that employs a protected moisture barrier. The floor protector includes a non-skid backing to enable it to remain in place for long durations under construction traffic, eliminating tapes and tactified materials. The present floor protector is reusable.

### SUMMARY

This section provides a general summary of the disclosure, and is not a comprehensive disclosure of its full scope or all of its features.

According to a first aspect of the disclosure, a floor protector comprises a pair of non-woven layers of material. A film or the like layer is bonded between the pair of non-woven layers. The film layer provides a moisture barrier or liquid impermeable feature. A non-skid layer is applied to one of the non-woven layers. The non-woven layers may be selected from a group comprising spunbond, spunlace, needle punch materials or combinations thereof. The non-skid layer may be selected from a group comprising polyvinyl chloride, styrene-butadiene rubber, natural rubber, hot melt, adhesives or a combination thereof. The non-skid layer may include a pattern including gaps with adjacent bumps of the non-skid material between the gaps. The non-skid layer may be discontinuous. Also, the non-skid layer spans from side to side of the non-woven layer material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of the floor protector.

FIG. 2 is a perspective rear view of FIG. 1.

FIG. 3 is a planned view of FIG. 2

FIG. 4 is a cross-section view of FIG. 3 along line 4-4 thereof.

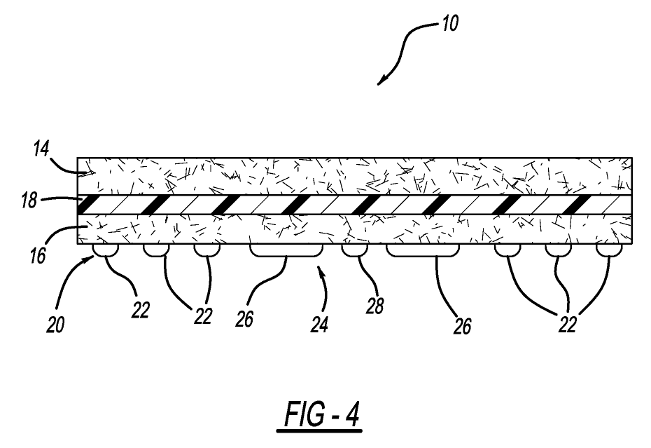

FIG. 5 is a plan view of another embodiment of the floor protector.

### DETAILED DESCRIPTION

Example embodiments will now be described more fully with reference to the accompanying drawings.

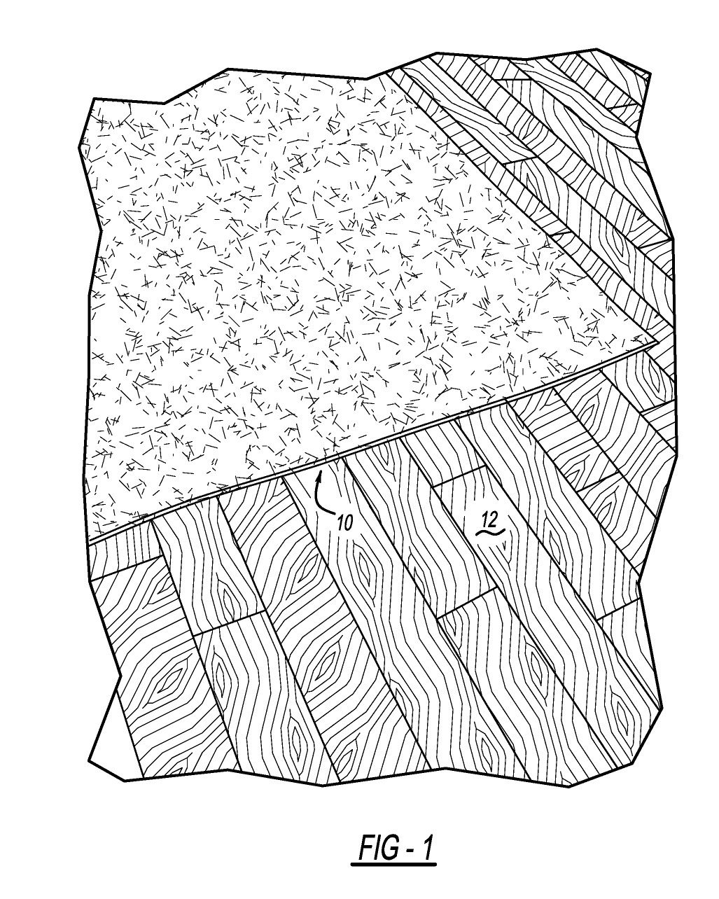

Turning to FIG. 1, a floor protector is illustrated and designated with the reference numeral 10. The floor protector 10 is positioned on top of a finished floor 12. The floor protector 10 provides protection to the finished floor 12 due to construction traffic that is still passing through the building while it is being completed. The floor protector 10 includes a first non-woven layer 14 and a second non-woven layer 16. A film 18 is sandwiched between the non-woven layers 14, 16 to bond with the non-woven layers 14, 16 to laminate the two together. A non-stick or non-skid layer 20 is positioned onto the non-woven layer 16.

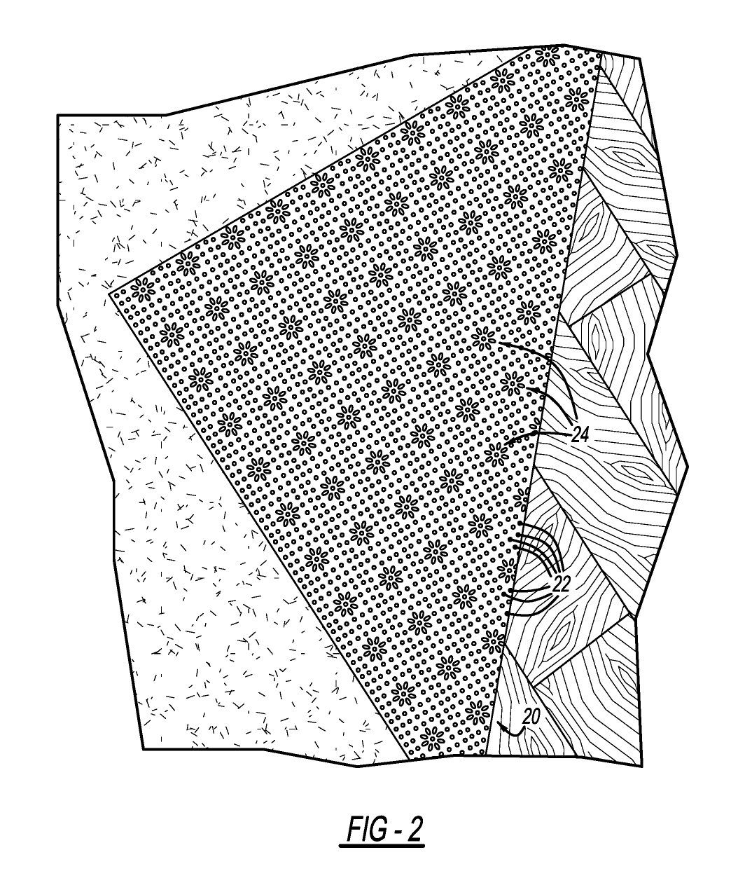

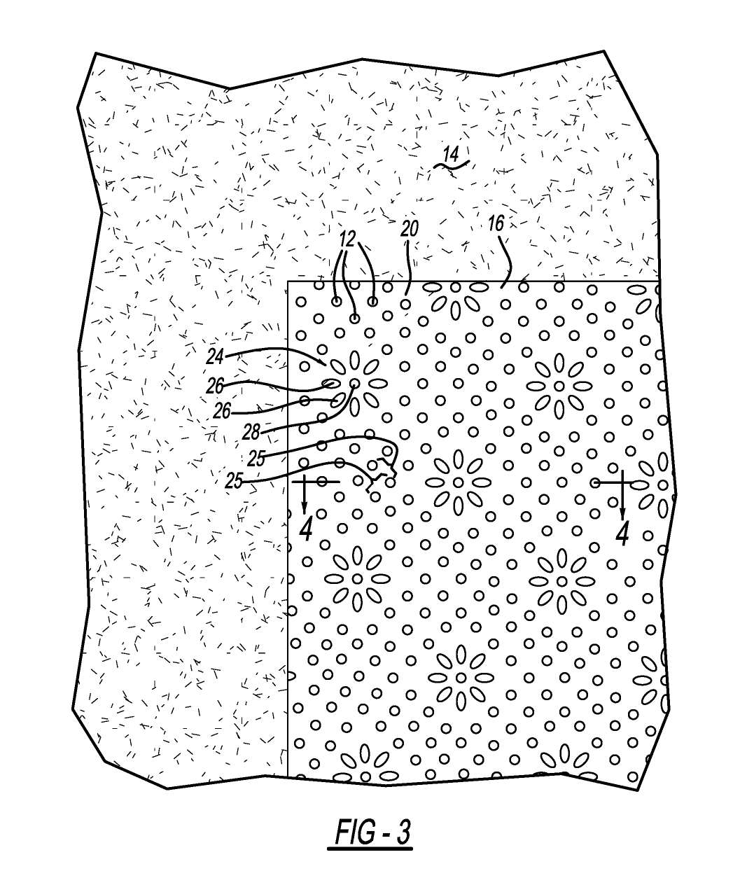

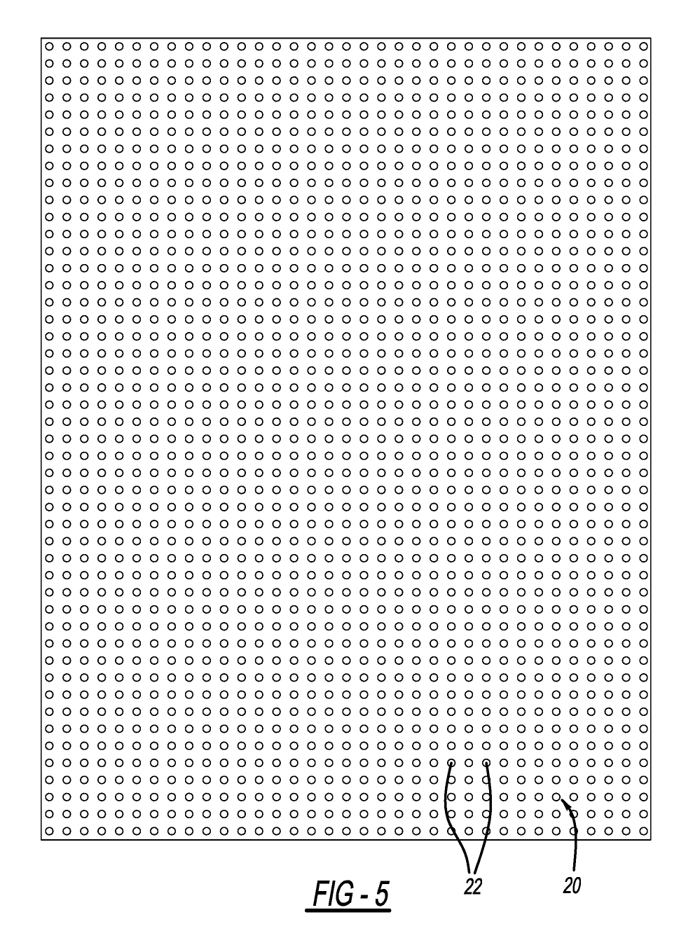

The non-woven layers 14, 16 can be manufactured from various materials. Generally, the non-woven materials are spunbond, both pointbond and flatbond. The non-woven material can be spunlace or needle punch material. The non-skid or non-slip layer 20 may be polyvinyl chloride with softening agents (PVC), a styrene butadiene rubber (SBR), natural latex rubber, hot melt and adhesives. The non-skid layer 20 is ordinarily positioned on the non-woven layer 16 in various patterns. The pattern illustrated, in FIGS. 2 and 3, include a plurality of bumps 22 with a generally circular configuration. A flower like design 24, having petals 26 and a stamen 28 is between the adjacent bumps 22. The bumps 22 create gaps 25 between each of the adjacent bumps 22 and flowers 24 so that each bump 22, petal 26 and stamen 28 provides a raised portion. Thus, the non-skid layer 20 is discontinuous and spans across the non-woven layer 16 from side to side. Additionally, the non-skid layer 20 is bonded or adhered to the non-woven layer 16 from side to side. FIG. 5 illustrates an additional non-skid layer 20 pattern. Here, the non-skid layer 20 includes bumps 22. The circularly configured bumps 22 span from side to side and top to bottom across the non-skid layer 16. While the bumps 22 are illustrated in a uniform continuous pattern, it is possible to have a random pattern on the non-skid layer 16.

The film layer 18 is positioned between the non-woven layers 14, 16. The film layer 18 provides an impermeable moisture or liquid barrier for the floor protector 10. Thus, if liquid or the like is spilled on the floor protector 10, the liquid will not pass through the floor protector 10. The non-woven layers 14, 16 protect the film layer 18 from being damaged during use.

The two layers of non-woven material 14, 16 are bonded together with the film 18, such as a polyethylene film. Heat and pressure is utilized to bond the non-woven layers 14, 16 with the film layer 18. Thus, the two non-woven layers 14, 16 are laminated with the film layer 18. Generally, the non-woven layer 16 is of a spunbond material to provide structural integrity. A needle punch material is generally used for the non-woven layer 14. This provides shock absorption and liquid absorption to prohibit liquids from running off of the floor protector 10. The polyethylene film 18 is used to bond the two non-woven fabric layers together but also provides a moisture barrier. Thus, fluids do not transfer through the protector 10 from the top non-woven layer 14 to the floor 12 below. A layer 20 of non-skid material is supplied or adhered to the non-woven layer 16 of the spunbond material. The non-skid layer 20 faces the floor 12 to prohibit the non-woven fabric layer 16 from sliding on the floor 12. This provides a tape free insulation in most applications.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A floor protector comprising:
a pair of non-woven material layers;
a film layer is bonded between the pair of non-woven material layers, the film layer providing a moisture barrier; and
a non-skid material layer is applied on one of the non-woven layers.

2. The floor protector according to claim 1, wherein the non-woven layers are selected from a group comprised of spunbond, spunlace, needle-punch materials or combinations thereof.

3. The floor protector according to claim 1, wherein the non-skid layer is selected from a group comprised of PVC, SBR, natural rubber, hot melt, adhesives or a combination thereof.

4. The floor protector according to claim 1, wherein the non-skid material layer includes a pattern.

5. The floor protector according to claim 1, wherein the non-skid material layer includes gaps between adjacent bumps of non-skid material.

6. The floor protector according to claim 1, wherein the floor protector is impermeable to liquid.

7. The floor protector according to claim 1, wherein the non-skid layer may be discontinuous.

8. The floor protector according to claim 1, wherein the non-skid layer spans from side to side of the non-woven layer.

9. The floor protector according to claim 1, wherein the floor protector is reusable.

10. The floor protector according to claim 1, wherein one non-woven layer is a needle punch material.

11. The floor protector according to claim 1, wherein one non-woven layer is a spunbond material.

12. The floor protector according to claim 11, wherein the non-skid layer is applied to the spunbond material.

13. The floor protector according to claim 1, wherein the non-skid layer may be continuous.

14. The floor protector according to claim 1, wherein the non-skid layer includes a plurality of circular bumps.
